(19) United States
(12) Patent Application Publication
(10) Pub. No.: US 2003/0004755 A1
(43) Pub. Date: Jan. 2, 2003

(54) Internet based custody and control form for laboratory testing

(76) Inventors: Russell Basch, Richmond, VA (US); David S. Gal, Richmond, VA (US)

Correspondence Address: John H. Thomas, P.C., 1561 East Main Street, Richmond, VA, 23219, US

(21) Appl. No.: 10/146,597

(22) Filed: May 15, 2002

Related U.S. Application Data
(60) Provisional application No. 60/291,021, filed on May 16, 2001.
(60) Provisional application No. 60/265,577, filed on Feb. 2, 2001.

(51) Int. Cl. G06F 17/60

(52) U.S. Cl. 705/2

(57) ABSTRACT

An internet-based system and method for producing and managing a legally binding Custody and Control Form for laboratory testing includes handling, controlling and delivering the donor information and test results on an internet web page. The electronic COC form prevents possible errors and delays and operates efficiently to collect and distribute test information.

This application claims benefit from U.S. Provisional Application Serial No. 60/291,021, filed May 16, 2001, which was a continuation in part of and claims benefit in part from U.S. Provisional Application Serial No. 60/265,577, filed Feb. 2, 2001.

### FIELD OF THE INVENTION

This invention relates to a new system and method for on-line production and storage of Custody and Control Forms for laboratory testing.

### BACKGROUND OF THE INVENTION

Custody and Control (COC) forms have been used for many years by laboratories as a means of recording donor information and assuring that specimens do not get separated from the donor information. Every specimen sent off for testing and/or analysis at a laboratory is accompanied by this COC form to assure legal chain of custody and to assure that specimens are always matched with the donor information. Hundreds of thousands of tests are sent from doctors' offices, clinics, and hospitals on a daily basis for laboratory testing. Specimens sent to the laboratory include, but are not limited to, blood, urine, saliva, stool, tissue, vaginal swabs, semen, and other bodily fluids. Each specimen requires that a multi-part COC form be filled out by the donor and the collector. Generally one part of the form goes to the donor, one to the collector, one to the person requesting the specimen (e.g. doctor, employer), and one, two, or three parts accompany the specimen to the laboratory.

The Custody and Control form has been well tested in the courts and is regularly used for such legal tests as DNA testing, forensic drug-testing, and genetic testing. The present Custody and Control form is a pre-printed multi-part form. The form is unique to each laboratory and often to each customer of the laboratory. For instance, each doctor's office, clinic, and hospital generally has its own unique forms that are usually barcoded with the account information and test requested. This allows the laboratory to quickly scan the barcode when the specimen arrives at the laboratory and direct the result and billing to the proper place.

FIG. 1 illustrates the flow of the present method for creating and handling COC forms.

Disadvantages of the Paper COC Form (Present Form)

The disadvantages of the present system for tracking custody and control include:

1. COC forms are expensive to produce and many are wasted.

2. For every COC form, as many as eight different copies must be shipped or mailed to different locations, which is expensive, time consuming, and allows for the possibility that COC forms will get lost in transit.

3. COC forms are difficult to fill out, and prone to errors.

4. COC forms require enormous storage space at the collection site, the Third Party Administrator, the Medical Review Officer (“MRO”), the Laboratory, and the Employer.

5. COC forms require tremendous use of labor and space resources to store and retrieve, and are often lost, resulting in collection sites not getting paid, additional time spent attempting to locate other copies of the form, and sometimes a need for a new specimen from the donor.

6. COC forms are sometimes hard to read (especially the last few parts of the multi-part form), which results in expensive errors.

7. The time delay in shipping COC forms from the laboratory to the MRO causes workers who test positive for drugs to stay on the job for several days after the test has been concluded, resulting in the potential for significant damage to be caused on the part of the drug abuser while still on the job.

### SUMMARY OF THE INVENTION

Accordingly, it is the object of the present invention to provide an online system for creating and handling COC forms (for laboratory testing). The resulting information is then made available via an internet work page.

In one embodiment, the present invention is a method of producing a form for laboratory testing involving a donor, a laboratory, and a collection site administrator. The method includes providing an internet web page, CPU's having internet access, a printer, electronic signature pads, and a barcode scanner. The collection site administrator has at least a CPU having internet access, a printer, and an electronic signature pad. The laboratory has at least a CPU having internet access, electronic signature pad, and a barcode scanner. The method further includes collecting a specimen from the donor at a collection site administrator and inputting information about the specimen into a laboratory testing form that is printed at the collection site administrator. A barcode is affixed to the specimen, the barcode having been printed at the collection site administrator. Next, the donor executes his or her signature on the electronic signature pad at the collection site administrator attesting to the accuracy of information in the laboratory testing form and to the validity of the specimen. The specimen is then delivered to the laboratory where the identity and validity of the specimen is confirmed by using the barcode scanner. The laboratory then performs a test on the specimen and inputs test results into the CPU at the laboratory. Those test results are confirmed by executing the electronic signature pad at the laboratory. Finally, the test results are posted on the internet web page. Additionally, the barcode affixed to the specimen may represent a unique identifier for a specific laboratory. Also, the internet web page may include security features that limit access to the web page.

In a further embodiment, the present invention includes a method for producing and storing a laboratory testing form, the method involving a donor, a laboratory, a collection site administrator, and a requestor. The method includes providing an internet web page, a plurality of CPU's having internet access, a printer, electronic signature pads, and a barcode scanner. The requestor has at least a CPU having internet access. The collection site administrator has at least a CPU having internet access, a printer, and an electronic signature pad. The laboratory has at least a CPU having internet access, an electronic signature pad, and a barcode scanner. The laboratory testing form is created on the CPU at the requester by inputting information regarding the donor. A specimen is collected form the donor at a collection site administrator. Information about the specimen is input into the laboratory testing form at the collection site administrator. A barcode is affixed to the specimen, the barcode having been printed either by the requester or the collection site administrator. The donor then executes his or her signature on the electronic signature pad at the collection site administrator attesting to the accuracy of information in the laboratory testing form and to the validity of the specimen. The specimen is then delivered to the laboratory where the identity and validity of the specimen are confirmed using the barcode scanner. A test is performed on the specimen at the laboratory, and test results are input in to the CPU at the laboratory. The tests results are confirmed as valid by the laboratory executing the electronic signature pad. The tests results are then posted on the internet web page.

### BRIEF DESCRIPTION OF THE DRAWINGS

FIG. 1 is a flow chart describing current methods for handling custody and control forms.

FIG. 2 is a flow chart illustrating a preferred embodiment of the present invention.

FIGS. 3 through 8 illustrate exemplary user interface screens and a sample form used in the present invention.

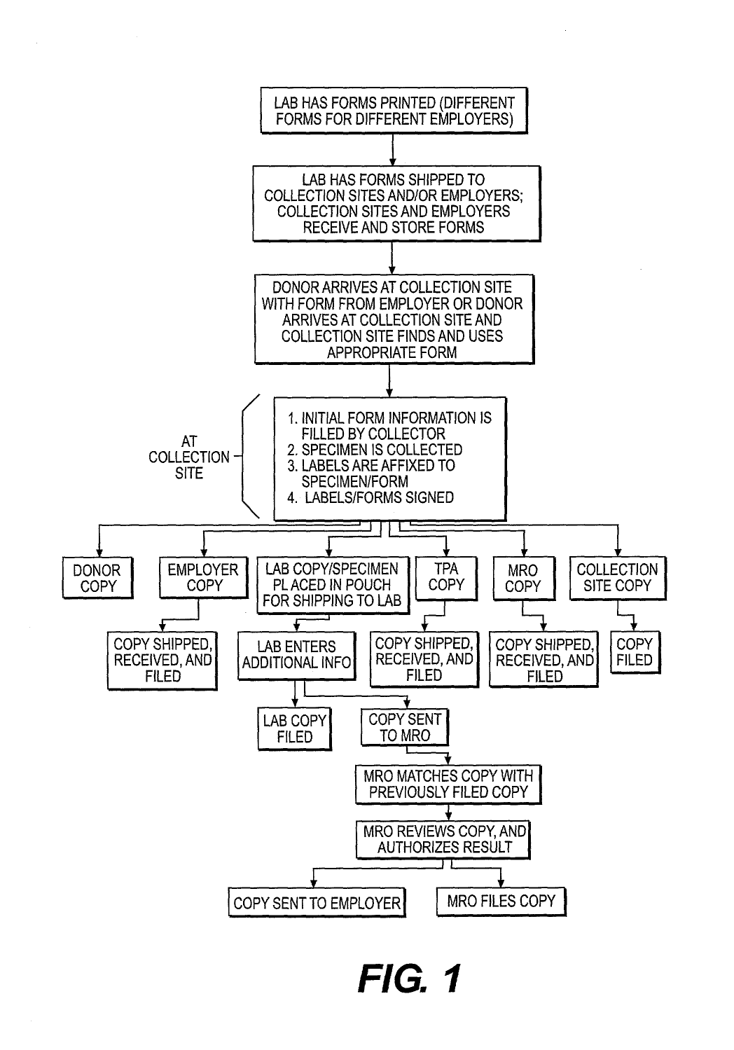

### DETAILED DESCRIPTION OF THE INVENTION

The present invention relates to an Internet implementation of a custody and control (COC) form. The present invention eliminates the use of the paper multi-copy form, reduces the chance for errors, eliminates the shipping and time necessary to send the forms, the storage space required for the forms, and the labor associated with sending, storing, and retrieving forms.

Under the present invention, a specimen donor simply shows up at a collection site. The collector proceeds to enter basic information, such as employer name and type of test, into the appropriate fields on the collector's computer screen, with such computer (CPU) being linked to a database through the Internet. In the preferred embodiment of the present invention, the software that implements the method includes fields that are limited to accept only specific information in order to filter errors and act as a self-correcting mechanism. Only a few relevant fields are displayed on the screen at any one time, so that the collector must enter information in the appropriate sequence, preventing additional errors. Also, in the preferred embodiment, many fields are auto-filled based on previously entered fields, so at to prevent errors and expedite the collector's task of entering information.

After the collector enters all the required fields prior to the donation of the specimen, a unique COC number is automatically assigned by the system. This number must have been previously requested and uploaded from the appropriate laboratory, and the number is assigned based on the laboratory the specimen is to be sent to, which in turn is determined based on the fields just previously entered by the collector. (Preferably, each laboratory has a predetermined range of unique COC numbers allotted to it). Other factors, such as employer, may also influence the COC number assigned. Special barcode generation software is then applied by the system to convert the COC # into barcode form.

After the specimen is collected, the collector may be asked to enter additional information (e.g. the temperature of the specimen), and is then prompted to print the requisite labels, which are printed from a label printer connected to the collector's CPU. Labels are affixed to the specimen(s) and to the pouch used to transport the specimen. The donor may by asked to initial the label(s) affixed to the specimen(s). The collector and donor must then sign the COC form using the electronic signature pad connected to the collector's CPU. An electronic COC form is then generated, which is visually substantially equivalent to a standard paper COC form.

A hard paper copy of the electronic COC form is printed for the donor to maintain for the donor's personal records, and the electronic COC information is stored in the database. This stored data can be electronically accessed and queried remotely by the Medical Review Officer (MRO), Third Party Administrator (TPA), Collection site, Employer, the Laboratory, and/or any other legitimate party using an appropriate password or other type of security. In the preferred embodiment of this invention, the information displayed on each party's computer screen will be customized based on the nature of the party (e.g., MRO, TPA etc.), the particular party (e.g., a specific TPA), and the role of the individual (e.g. collector) accessing the information. This customization is accomplished based on the user's login identification and a profile assigned to each login. Customization includes both the “look and feel” of the site as well as restrictions on access and auto-fill of predetermined fields.

Upon receipt of the specimen, the laboratory uses a barcode scanner connected to a CPU and the COC database to scan the barcode off the label affixed to the specimen(s). This action prompts the system to query the database and retrieve information for the matching COC form. The laboratory then enters appropriate fields in the electronic form through CPU, including test results, after which the laboratory scientist signs the form using an electronic signature pad connected to the computer. Once the lab's testing is complete, the MRO accesses the database and queries the database for unreviewed laboratory results. The MRO subsequently enters the appropriate fields in the electronic form, either confirming or rejecting the results. The MRO certifies the results by signing the electronic COC form using an electronic signature pad connected to the MRO's computer. Finally, the employer is informed of the certified test result. In the preferred embodiment this result is sent via an electronic message.

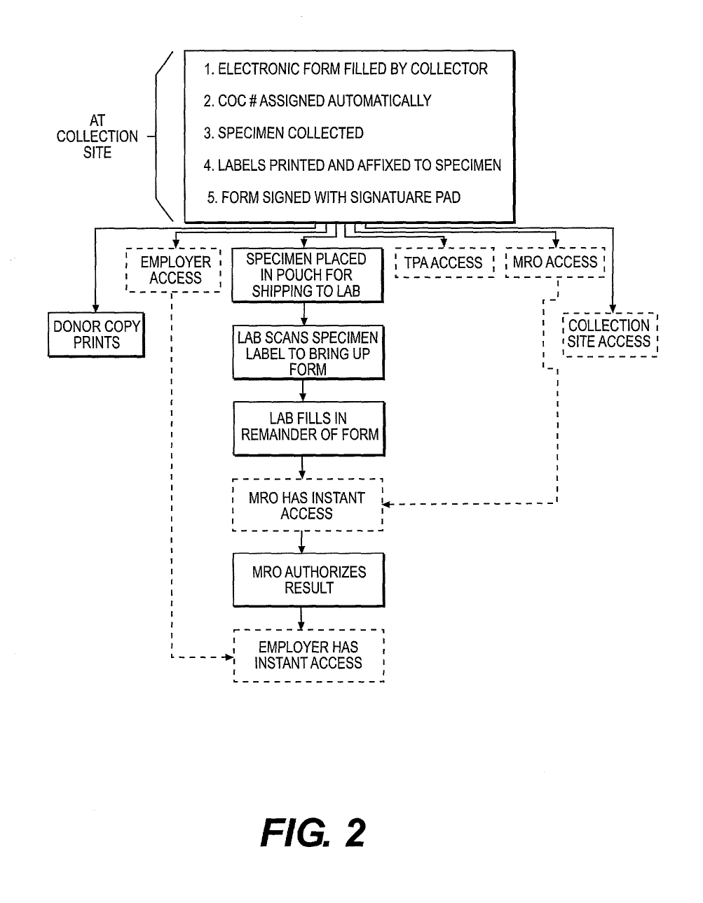

FIG. 2 illustrates the flow of the method in accordance with the method described thus far herein. The dotted lines indicate information that is available over the internet via a predesignated web page that facilitates flow of this information.

In another preferred embodiment of the present invention, the COC is viewed as part of a larger data management process such as an employment screening and hiring process. Other persons or entities than just the collection site administrator may be a requestor and may input donor information and originate the laboratory testing form. For instance, upon a hiring manager's decision to send an applicant (donor) for a laboratory test, the hiring manager may be a requester. The hiring manager can prompt the Internet-based system to begin processing an applicant and the fields identifying the donor are automatically filled from information stored in the company's hiring management system. Also, fields identifying the employer are automatically filled from information stored in the COC data system and a unique COC number is automatically assigned by the system. This number must have been previously requested and uploaded from the appropriate laboratory, and the number is assigned based on the laboratory the specimen is to be sent to, which may be based on a number of factors including location and employer. Alternatively, a hiring manager manually enters the information in the fields identifying the donor and the employer.

Preferably, the hiring manager associated with each COC is recorded by the system based on the login identification of the hiring manager. Also, the time and date when the applicant is requested to provide a specimen is recorded. This is done automatically when the hiring manager requests that the applicant provide a specimen more or less simultaneously with prompting the COC system to begin processing the applicant. In another embodiment, the hiring manager prompts the system to track the time and date at the time that the applicant is requested to provide a specimen, while the hiring manager prompts the system to process the applicant at a separate time. In a still further embodiment, the hiring manager manually enters the time and date that the applicant was requested to provide a specimen. The time and date that an applicant is requested to provide a specimen can be matched with the time and date of collection, such information is recorded, and in the event that such time exceeds the time permitted by the hiring manager, an alert is posted with the test result.

When the donor is ready to donate a specimen at the collection site, the collector prompts the internet-based system to pull up the relevant COC by entering identifying information such as the donor's social security number or the COC number. The collector then proceeds to enter the remaining relevant information as described above and the donor and collector sign the forms using the signature pad as described above. The collector prints a copy of the COC form and the associated labels when prompted to do so by the system. In the preferred embodiment of this COC form, a laser printer is used and the paper used to print the form has two labels affixed to the bottom portion, so that both the information on the form and the labels can be printed simultaneously. The COC form produced with the associated labels is sent to the lab with the specimen. A copy of the COC form can be printed for each of the donor, MRO, and an additional lab copy. Each copy may be different in appearance. Multiple copies can be facilitated by use of a laser printer with 2 trays, one tray for paper with affixed labels and one with regular paper.

In another embodiment of the present invention, the hiring manager or other requestor prints out a COC form with the employer information filled, barcoded COC number, donor information filled, and with labels attached to the form identifying the COC number and hands the form to the donor to take with him to the collection site. In the preferred embodiment of this COC form, a laser printer is used and the paper used to print the form has two labels affixed to the bottom portion, so that both the information on the form and the labels can be printed simultaneously. At the collection site, the collector proceeds to fill the rest of the form using standard procedures. The collector may then make a copy of the completed form for the donor as well as other copies. In order to insure that the donor can constantly observe the collector, it may be necessary to install the copier in the same room where the form is filled.

In another alternative feature of the present invention, when the MRO receives an electronic test result from the lab, the COC system will receive identifying information from the test result and will send an indication signal if the signed COC form has been or has not been received from the collection site through the system. This indication will be displayed for the MRO along with the result. Furthermore, if the COC form has been received, the name of the donor will be automatically added to the test results.

The embodiments and discussion throughout refer to a barcode scanner and barcode technology generally. Other security technologies may be used such as holographic technology, other scanning technologies, biometric technologies, etc. It is believed that barcode technology is presently the most efficient and inexpensive security and identification system available.

Advantages of the On-Line COC Form

The on-line COC form addresses each of the disadvantages of prior art, hard copy COC forms, thereby resulting in monetary, time, and storage savings. Some of the savings are addressed below.

Cost Savings

A typical, existing 5-part COC form can cost as much as $0.50 each for those produced in small quantities to as little as $0. 10/each for those produced bulk. Laboratories generally agree that as many as 50% of the forms never get used. For each 100 forms that are sent to doctors' offices, clinics, etc. only about 50 are returned. Customers often request more forms than they need, so as not to run out.

In general, each form is uniquely barcoded for each customer. This means that each form needs to be printed, packaged and shipped. This requires human and capital resources. In addition, if a client decides to or is required to change laboratories, that client is asked to throw out the previous laboratory's forms, the forms may be changed by the laboratory or the Federal Government (as in the recent decision to change the form that is required for the Federally-mandated Department of Transportation Forensic Drug-testing Program) or the client or the laboratory may get bought out or go out of business. BeCPU'se nearly 50% of the forms do not get returned, the cost of the form is nearly double the actually printing costs.

Finally, the forms are heavy and thus are expensive to ship. Depending on the shipping destination and the number of forms that are shipped, shipping costs can often exceed $0.25 per form.

The on-line COC form requires no pre-printed forms, thus no shipping costs or storage costs. All information needed to properly fill out the COC form is stored in the hosting site's database. The collector simply logs on to the website, answers a few questions about the donor, the test(s) to be performed, the laboratory to which the specimen is to be sent, and information about the collector. From these answers, the appropriate form is created and can be printed to accompany the specimen to the laboratory, to give to the donor, and to give to the collector if desired. BeCPU'se the information is stored in the database, the form could be called up later by any of the interested parties. If changes are needed to a form, the company information changes, or the test requested information changes, there is now no need to print and ship out new forms. Simple changes can be made to the on-line form and made available to the entity that needs to use the form.

Easier to Fill Out, Resulting in Fewer Errors

The prior art COC forms require training to properly fill out. As many as 15 different items on the form may need to be filled out, checked, or signed in order for the laboratory to accept the specimen. Even with training, many COC forms are often filled out incorrectly. Some errors can be corrected, but to do so, the laboratory must obtain a signed affidavit from the collector in order to fix the error before the specimen can be tested and released to the client. This leads to increased costs, slower turn around time for the test result, and poorer customer service. Some COC errors cannot be corrected. In these cases, the entire collection must be redone with all the associated costs, including the COC form, the time and labor to redo the test, and the reshipping of the specimen to the lab.

In addition, errors are often made beCPU'se a form for the wrong test or the wrong client or the wrong laboratory is used. This can CPU'se the wrong test to be performed, the results reported to the wrong client, or the specimen to be sent to the wrong laboratory. These errors increase costs and decreased customer satisfaction.

With the on-line COC form, there is little chance of error. Through a series of simple questions, the proper client, as well as, the proper laboratory with the proper test and account number are selected. The form that is created is specific for the selected laboratory, the test, the client, and the donor.

Reduced Storage Space

Storage of the blank pre-printed COC forms is also a disadvantage of existing systems. One hundred multi-part forms are nearly 2″ thick. Some clinics may need to store thousands of blank forms. Laboratories may need to store tens of thousands of forms. Some collection sites, clinics, and corporate clients are likely to store a large quantity of forms, as well as, many different forms (for different locations, different tests, different labs, etc). Storing these, of course, can be a huge burden and expense.

Storage of the completed COC form is also a significant disadvantage and expense of the present system. A 5-part form requires that 5 different entities store one part of the form per test. Most tests require that the forms are stored for at least 12 months. Depending on the outcome of the test, some forms are required to be stored for up to 5 years or more (especially if the test is used as evidence). The cost of filing the form, storing the form, and if need be, retrieving the form is not insignificant.

Finally, another disadvantage is that the multi-part form requires the donor and the collector to press very hard in order for the last part of the form to be clear. Often the last copy or two are not clear. This can CPU'se confusion and in some cases, could make the test invalid or unenforceable.

With the on-line COC form, no storage of preprinted forms is required by the laboratory, the clinic, or the client. The forms are created at the point of service (typically the collection sites) with all the appropriate information that is gathered from the on-line questionnaire. Also, beCPU'se the information is gathered and stored into a central database there is no need to store all the copies of the filled out COC form. The laboratory may need to store the original copy of the form that was sent from the collection site, but the collector copy, the client copy and the requester copy are unnecessary.

### EXAMPLE OF PRESENT INVENTION

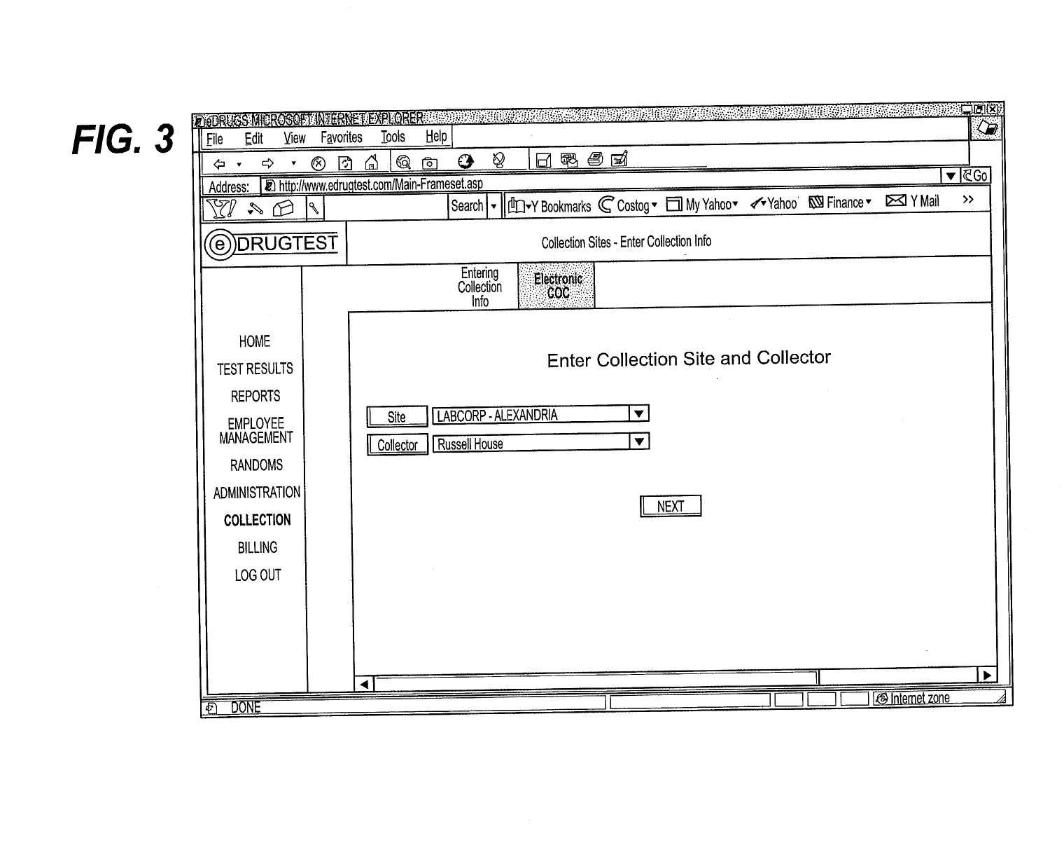

A commercial embodiment of the present invention is presently available at edrugtest.com. Attached as FIGS. 3-7 are a series of software interfaces that are used in connection with the commercial embodiment of the present invention.

FIG. 3 is an interface called up by a collector. Based on the collector's login security password, the appropriate collection site identification and the collector's name are automatically activated.

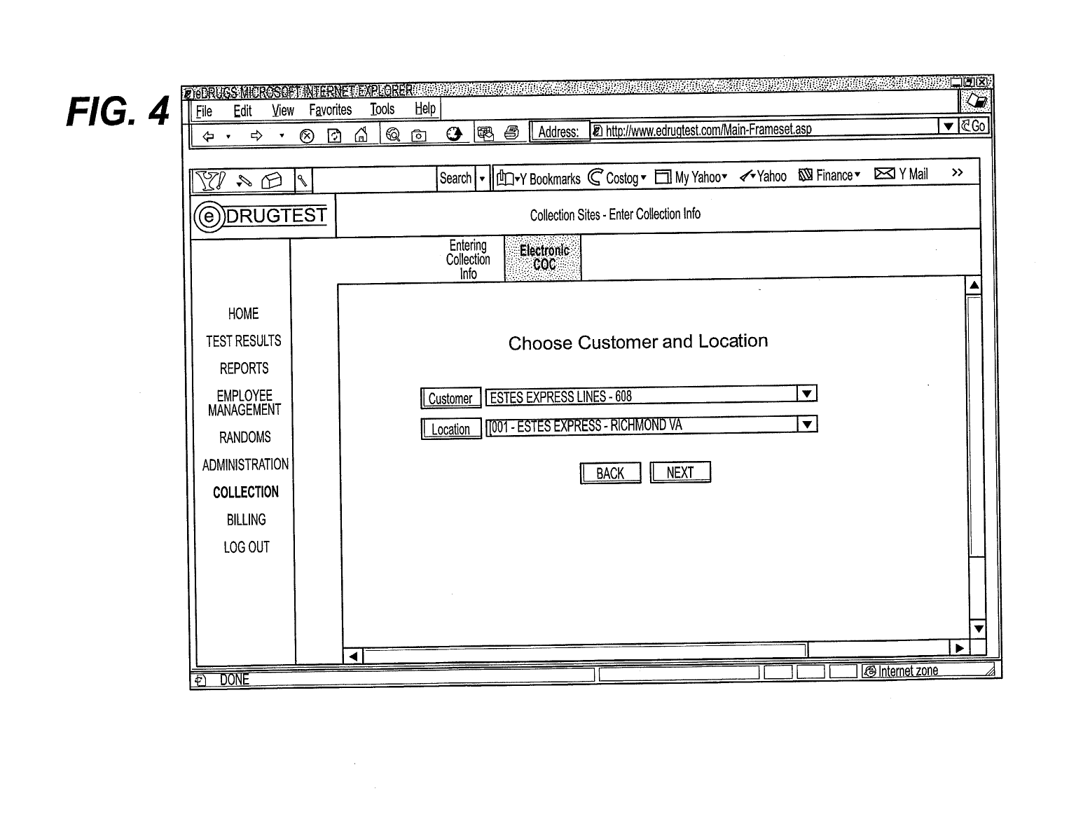

FIG. 4 is an interface screen that displays an employer who is requesting a drug test and the employer's location. Only those locations that are preapproved and set up for collections will appear in the pull-down menu.

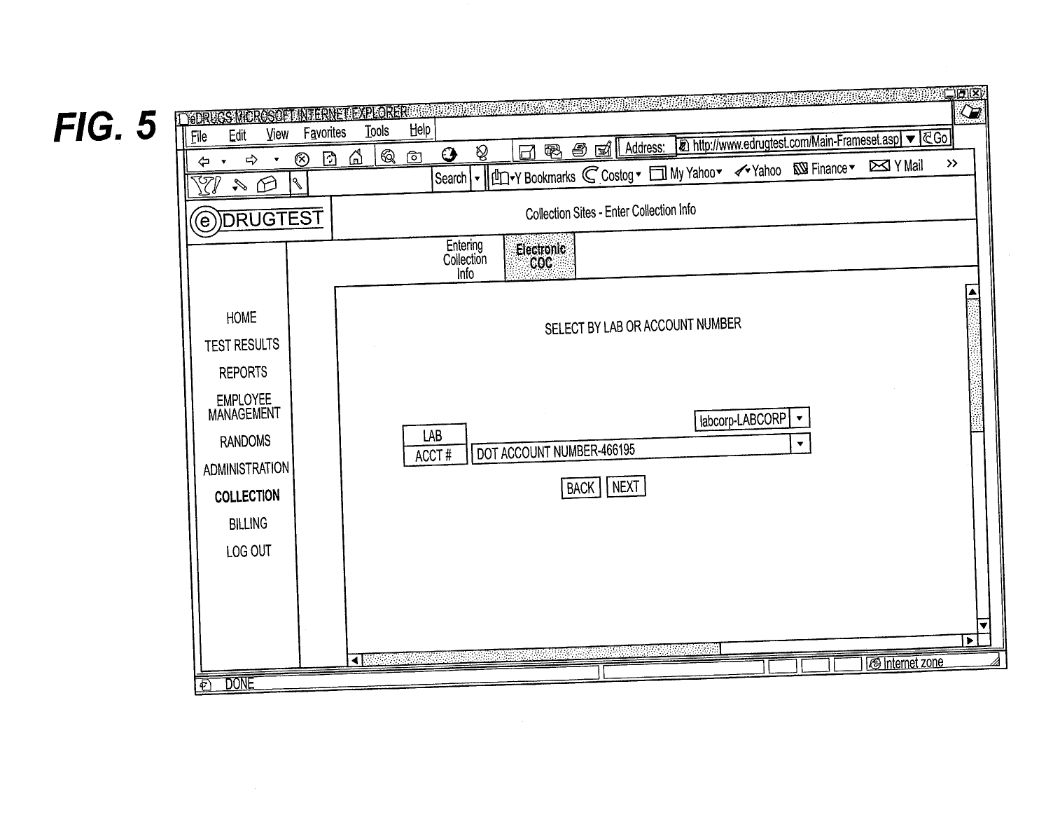

FIG. 5 is an interface in which an appropriate laboratory and account number (based on the particular laboratory and employer) are selected.

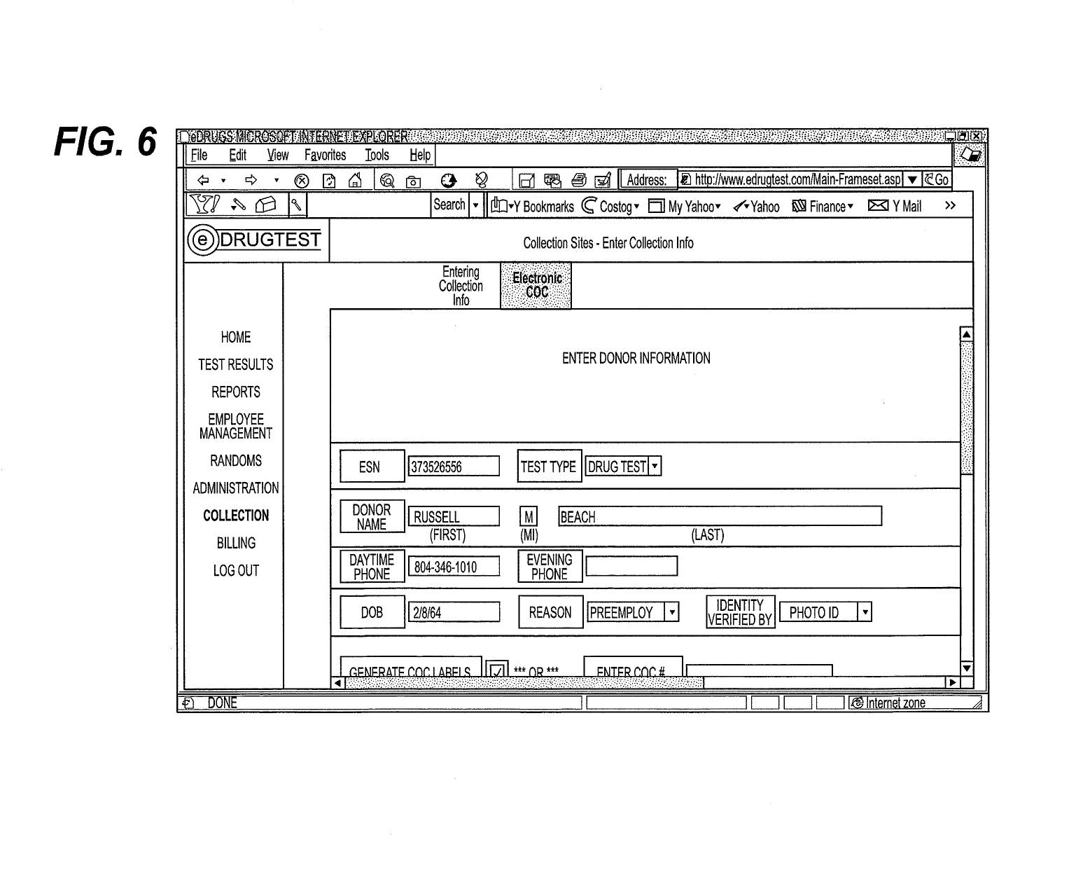

FIG. 6 is a portion of the interface screen in which the collector enters information about the donor and the type and purpose of the laboratory test. Subsequently, a chain of custody number is assigned. The software automatically checks for errors and ensures that all necessary information is completed before allowing the collector to proceed.

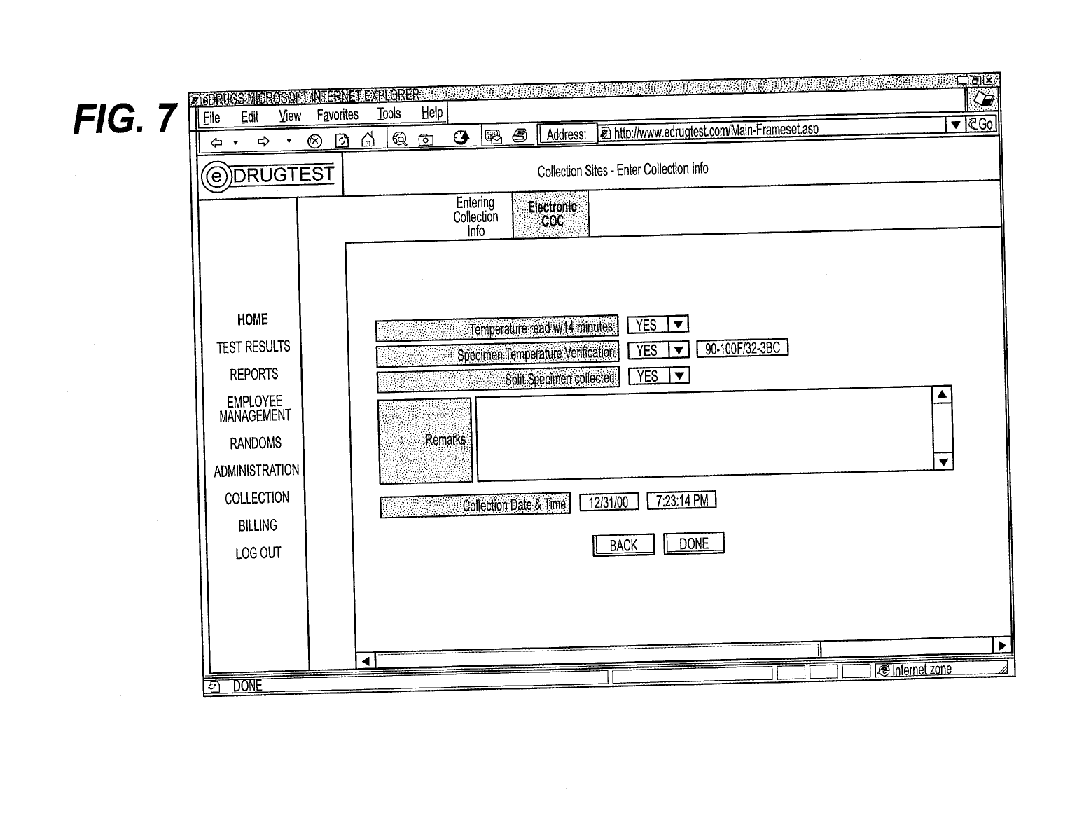

FIG. 7 is an interface that is also filled in at the collection site. In this step of the process, the specimen is collected and used to record the temperature range, date and time on which the specimen is collected.

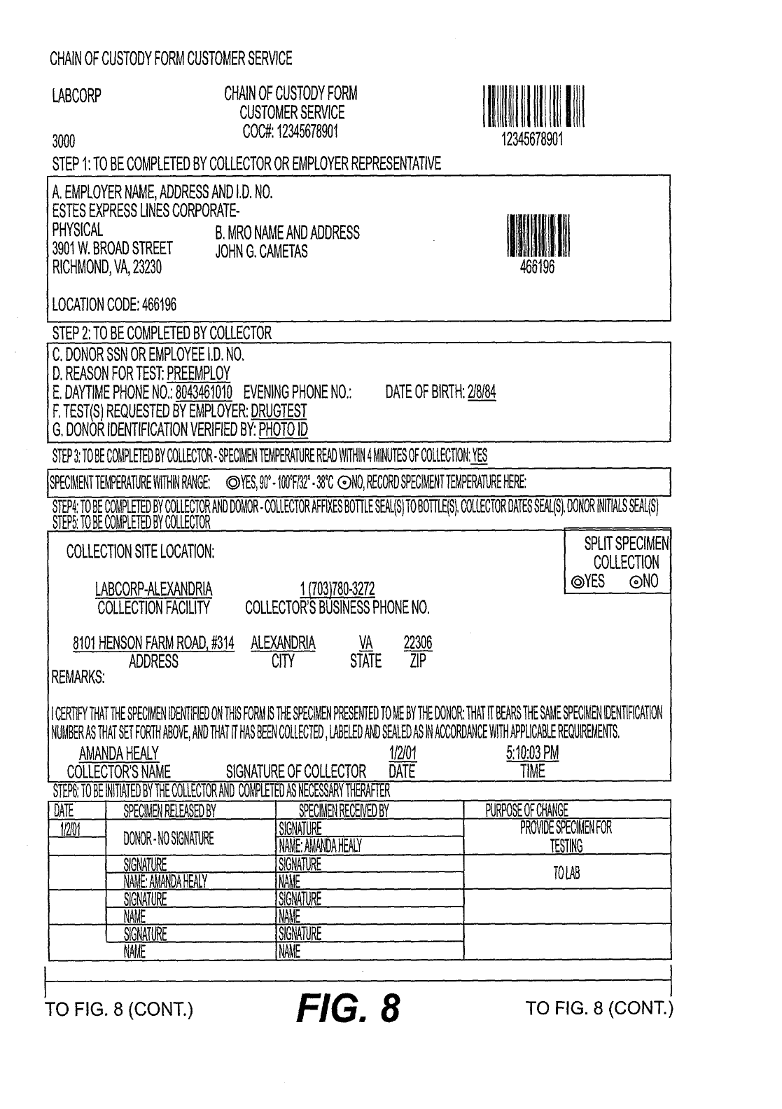

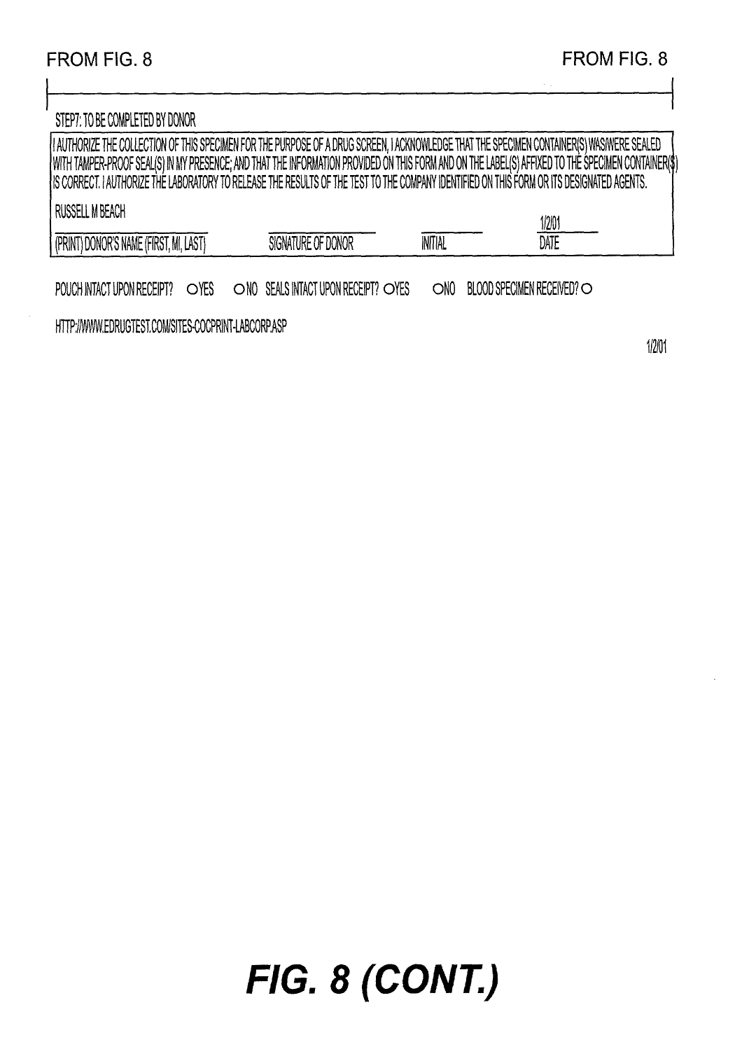

Finally, FIG. 8 is a representative chain of custody form that may be generated and printed out in hard form or electronically archived.

While the invention has been described with reference to specific embodiments thereof, it will understood that numerous variations, modifications and additional embodiments are possible, and accordingly, all such variations, modifications, and embodiments are to be regarded as being within the spirit and scope of the invention.

What is claimed is:

1. A method for producing a form for laboratory testing involving a donor, a laboratory, and a collection site administrator, the method comprising the following steps:
providing an internet web page, CPU's. having Internet access, a printer, electronic signature pads, and a barcode scanner,
wherein the collection site administrator has at least a CPU having Internet access, a printer, and an electronic signature pad; the laboratory has at least a CPU having Internet access, an electronic signature pad, and a barcode scanner;
collecting a specimen from the donor at a collection site administrator;
inputting information about the specimen into a laboratory testing form that is printed at the collection site administrator;
affixing a barcode to the specimen, the barcode having been printed at the collection site administrator;
having the donor execute his or her signature on the electronic signature pad at the collection site administrator attesting to the accuracy of information in the laboratory testing form and to the validity of the specimen;
delivering the specimen to the laboratory;
confirming the identity and validity of the specimen at the laboratory by using the barcode scanner;
performing a test on the specimen at the laboratory;
inputting test results into the CPU at the laboratory and confirming validity of those results by executing the electronic signature pad at the laboratory; and
posting the test results on the Internet web page.

2. A method as described in claim 1, wherein the barcode affixed to the specimen represents a unique indentifier for a specific laboratory.

3. A method as described in claim 1, wherein the internet web page comprises security features that limit access to the web page.

4. A method for producing and storing a laboratory testing form, the method involving a donor, a laboratory, a collection site administrator, and a requester, the method comprising the following steps:
providing an internet web page, a plurality of CPU's. having internet access, a printer, electronic signature pads, and a barcode scanner,
wherein the requestor has at least a CPU having internet access;
the collection site administrator has at least a CPU having internet access, a printer, and an electronic signature pad; the laboratory has at least a CPU having Internet access, an electronic signature pad, and a barcode scanner;
creating the laboratory testing form on the CPU at the requestor by inputting information regarding the donor;
collecting a specimen from the donor at a collection site administrator;
inputting information about the specimen into the laboratory testing form at the collection site administrator;
affixing a barcode to the specimen, the barcode having been printed either by the requester or the collection site administrator;
having the donor execute his or her signature on the electronic signature pad at the collection site administrator attesting to the accuracy of information in the laboratory testing form and to the validity of the specimen;
delivering the specimen to the laboratory;
confirming the identity and validity of the specimen at the laboratory by using the barcode scanner;
performing a test on the specimen at the laboratory;
inputting test results into the CPU at the laboratory and confirming validity of those results by executing the electronic signature pad at the laboratory; and
posting the test results on the Internet web page.
